(19) United States
(12) Patent Application Publication
(10) Pub. No.: US 2026/0149280 A1
(43) Pub. Date: May 28, 2026

(54) Coordinated Control Method for Energy Storage of Multi-Energy Complementary Distributed Microgrid

(71) Applicant: Guangdong Shunde Electric Power Design Institute Co., Ltd., Foshan (CN)

(72) Inventors: Zhihui TU, Foshan (CN); Zhengfei LIN, Foshan (CN); Zehuan CHEN, Foshan (CN); Hongfei XU, Foshan (CN); Wei WANG, Foshan (CN); Huanxia HU, Foshan (CN); Zhenshuo WANG, Foshan (CN); Yingde GAO, Foshan (CN)

(21) Appl. No.: 19/211,301

(22) Filed: May 19, 2025

(30) Foreign Application Priority Data
Nov. 27, 2024 (CN) 2024117074843

(51) Int. Cl. H02J 3/28; H02J 3/00; H02J 3/38; H02J 7/00

(52) U.S. Cl. CPC H02J 3/28; H02J 3/003; H02J 3/004; H02J 3/381; H02J 7/40; H02J 7/54; H02J 7/82; H02J 7/933; H02J 2101/24; H02J 2101/28; H02J 2101/40; H02J 2103/30; H02J 2103/35

(57) ABSTRACT

The present application discloses a coordinated control method for energy storage of a multi-energy complementary distributed microgrid, and relates to the technical field of microgrids. The coordinated control method includes: collecting and preprocessing renewable energy and energy storage unit data, monitoring, in real time, and predicting the load change of the microgrid and the fluctuation of a power generation capacity of the renewable energy, and generating short-term charging and discharging plans; and by means of a virtual leader algorithm, adjusting power distribution proportions of energy storage units in real time and dynamically adjusting charging and discharging rates of the energy storage units, and after the charging and discharging rates are adjusted, synchronizing voltages and frequencies of the different energy storage units. The accuracy of power and load prediction is improved; and the power distribution proportions and the charging and discharging rates of the energy storage units are dynamically adjusted.

### TECHNICAL FIELD

The present application relates to the technical field of microgrids, in particular to a coordinated control method for energy storage of a multi-energy complementary distributed microgrid.

### BACKGROUND ART

With the transformation of global energy structures, the application of renewable energy has gradually become an important approach for countries to achieve green and low-carbon development. Renewable energy such as photovoltaic and wind energy has significant advantages of environmental friendliness and sustainable development, however, due to its intermittence and instability, its application in large-scale grids is limited. In recent years, a distributed microgrid technology has gradually emerged, by which decentralized renewable energy systems are organically combined with energy storage units, so that the self-sufficiency and complementary application of local energy are achieved by reasonable scheduling control. Under an architecture of a distributed microgrid, the renewable energy is adjusted by an energy storage system, so that energy fluctuation can be effectively stabilized, and the stability and reliability of the system can be improved. However, there still are defects in the prior art, scheduling strategies of traditional energy management systems for the energy storage units and the renewable energy mostly rely on fixed rules, which cannot fully adapt to the real-time fluctuation of a load and a power generation capacity; and existing control methods are lack of intelligent adjustment mechanisms for power distribution and charging and discharging rate adjustment of the energy storage units, and often only rely on simple power balance algorithms for processing, which not only affects the operation efficiency of the energy storage system, but also may cause voltages and frequencies of the energy storage units to be asynchronous, thereby affecting the stability of the entire microgrid. Therefore, in the actual operation of the microgrid, how to achieve the coordinated optimization of a plurality of energy forms and especially balance a power generation capacity and a load demand by means of a more intelligent and real-time control strategy is a main challenge faced by the prior art.

### SUMMARY OF THE INVENTION

In view of the problem existing in the above-mentioned existing coordinated control method for energy storage of a multi-energy complementary distributed microgrid, the present application is provided.

Therefore, a problem to be solved in the present application lies in that how to achieve the coordinated optimization of a plurality of energy forms and especially balance a power generation capacity and a load demand by means of a more intelligent and real-time control strategy is a main challenge faced by the prior art.

In order to solve the above-mentioned technical problem, the present application provides the following technical solutions: a coordinated control method for energy storage of a multi-energy complementary distributed microgrid includes: collecting and preprocessing renewable energy and energy storage unit data, monitoring, in real time, and predicting the load change of the microgrid and the fluctuation of a power generation capacity of the renewable energy, and generating short-term charging and discharging plans;
by means of a virtual leader algorithm, adjusting power distribution proportions of energy storage units in real time and dynamically adjusting charging and discharging rates of the energy storage units, and after the charging and discharging rates are adjusted, synchronizing voltages and frequencies of the different energy storage units; and
storing data generated in a coordination process, and performing data backup.

As a preferred solution of the coordinated control method for energy storage of a multi-energy complementary distributed microgrid, the collecting and preprocessing renewable energy and energy storage unit data refers to deploying a sensor to collect photovoltaic and wind power generation data in the microgrid in real time, meanwhile, acquiring states of charges, power outputs, voltages and frequencies of the energy storage units, preprocessing the acquired data, removing data noise and outliers, and performing smoothing.

As a preferred solution of the coordinated control method for energy storage of a multi-energy complementary distributed microgrid, the monitoring, in real time, and predicting the load change of the microgrid and the fluctuation of a power generation capacity of the renewable energy refers to predicting a load of the microgrid by using an LSTM (Long Short Term Memory) model, extracting historical and real-time photovoltaic and wind power generation data features by using a feature engineering, inputting the extracted historical data feature as a training set to the LSTM model for model training, defining a loss function and an Adam optimizer to perform iterative optimization of model parameters, stopping iteratively outputting the model parameters for updating the LSTM model when the loss of the LSTM model is no longer reduced significantly in a process of continuous iteration, and inputting the real-time photovoltaic and wind power generation data feature to the LSTM model to obtain future photovoltaic and wind power generation data; and
predicting short-term load fluctuation of the energy storage units by using an ARIMA (Autoregressive Integrated Moving Average) model, collecting and inputting historical load data to the ARIMA model for model training, determining model parameters by maximum likelihood estimation, stopping iteratively outputting the model parameters for updating the ARIMA model when the loss of the ARIMA model is no longer reduced significantly in a process of continuous iteration, and inputting real-time load data of the energy storage units to the ARIMA model to obtain future load data.

As a preferred solution of the coordinated control method for energy storage of a multi-energy complementary distributed microgrid, the generating short-term charging and discharging plans refers to computing a power difference according to a power prediction result and a load prediction result, determining charging and discharging states of an energy storage system, if the power difference is greater than or equal to 0, indicating that the power generation capacity is excessive and the system is to charge the energy storage units, and if the power difference is less than 0, indicating that the power generation capacity is insufficient and the system requires the energy storage units to discharge.

As a preferred solution of the coordinated control method for energy storage of a multi-energy complementary distributed microgrid, the by means of a virtual leader algorithm, updating power distribution of energy storage units in real time and dynamically adjusting charging and discharging rates of the energy storage units refers to computing a total power demand required to be borne by the energy storage units within the current time period according to a microgrid load demand predicted in the short-term discharging plan and power of the renewable energy;
establishing a communication network among the energy storage units, and distributing an initial power demand to each energy storage unit according to the computed total power demand and the SOC (state of charge) of each energy storage unit;
defining a communication weight between an energy storage unit i and an energy storage unit j, selecting an energy storage unit with the SOC closest to SOCₘₐₓ as a leader, setting the selected leader as B=1, using the remaining energy storage units as followers, setting that 0<B≤1, and sharing state information by each energy storage unit by means of the communication network among the energy storage units;
after the communication network is established, continuously adjusting power distribution of each energy storage unit according to the guidance of the leader, and updating the power distribution of each energy storage unit according to a formula:

$${x}_{i} [ k + 1 ] = {\sum }_{j = 1}^{N} {α}_{i , j} {x}_{j} [ k ] + B \cdot λ \cdot Δ {x}_{i} [ k ] ,$$

wherein xᵢ[k+1] is a power distribution proportion of the energy storage unit i at time k+1, α_{i,j} is a communication weight between the energy storage units i and j, B is a leader indication parameter, λ is a coupling coefficient of a leader influence, and Δxᵢ[k] is a power distribution adjustment quantity of the energy storage unit i in a k^{th} iteration;
adjusting, by each energy storage unit, a power output thereof for iteration according to information transferred by the communication network and the guidance of the leader, setting a threshold of the number of iterations of the power distribution as Q, and when the number of iterations reaches the threshold Q, outputting a final power distribution proportion of each energy storage unit;
converting the distribution proportion into a power distribution value of each energy storage unit by means of a proportional distribution algorithm;
computing charging and discharging rates I of each energy storage unit according to a computed power distribution result:

$$I = \frac{W}{A} \times ( \frac{{SOC}_{max} - {SOC}_{b}}{{SOC}_{max}} ) ,$$

wherein W is a power output, A is a voltage, SOCₘₐₓ is the maximum state of charge of the energy storage unit, and SOC; is the current state of charge of the energy storage unit; and
adjusting actual power output situations of the energy storage units according to the computed charging and discharging rates.

As a preferred solution of the coordinated control method for energy storage of a multi-energy complementary distributed microgrid, the after the charging and discharging rates are adjusted, synchronizing voltages and frequencies of the different energy storage units refers to after power distribution and charging and discharging rate adjustment are completed, acquiring the current frequency and voltage of each energy storage unit, and computing a frequency synchronization adjustment input

$${u}_{i}^{ω}$$

and a voltage adjustment input

$${u}_{i}^{V}$$

according to a frequency difference of the energy storage unit i and the energy storage unit j by means of a consensus algorithm:

$${u}_{i}^{ω} = - {\sum }_{j = 1}^{n} {w}_{ij} \frac{{( {ω}_{i} - {ω}_{j} )}^{η}}{1 + tanh ( ξ ( {θ}_{i} - {θ}_{j} )} + exp ( - \frac{\vert {P}_{i} - {P}_{j} \vert}{γ} ) ,$$

$${u}_{i}^{V} = min ( {U}_{max} , max ( 0 , - {w}_{ij} \frac{{( {V}_{i} - {V}_{j} )}^{2}}{1 + {e}^{- λ ( {ϕ}_{i} - {ϕ}_{j} )}} + \frac{1}{1 + {e}^{- ϛ ( {Q}_{i} - {Q}_{j} )}} ) ) ,$$

wherein Wᵢⱼ is a coupling weight between the energy storage units i and j, ωᵢ and ωⱼ are frequencies of the energy storage units i and j, η is a power of the frequency difference, ξ is an adjustment coefficient of a phase angle difference, tanh( ) is a hyperbolic tangent function, θᵢ and θⱼ are phase angles of the energy storage units i and j, Pᵢ and Pⱼ are power outputs of the energy storage units i and j, γ is an attenuation coefficient of power loss, Vᵢ and Vⱼ are voltages of the energy storage units i and j, λ is an adjustment coefficient of a voltage phase angle, φᵢ and φⱼ are voltage phase angles of the energy storage units i and j, ξ is an adjustment coefficient of reactive power synchronization, Qᵢ and Qⱼ are reactive powers of the energy storage units i and j, and Uₘₐₓ is the maximum voltage adjustment range; and
adjusting the frequencies and the voltages of the energy storage units in real time according to computed synchronous inputs, updating the frequencies and the voltages of the energy storage units, and gradually synchronizing the frequencies and the voltages of the different energy storage units.

As a preferred solution of the coordinated control method for energy storage of a multi-energy complementary distributed microgrid, the storing data generated in a coordination process refers to recording, in real time, an operation log generated in a process of coordinated control for the microgrid, storing the collected energy storage unit data and photovoltaic and wind power generation data as well as coordinated control data generated by analysis into a database, sorting the database in chronological order, and marking corresponding labels.

As a preferred solution of the coordinated control method for energy storage of a multi-energy complementary distributed microgrid, the performing data backup refers to storing the data into the database, meanwhile, performing synchronous data storage by using a log file system and an internal memory database, setting a regular backup strategy, and regularly backing up historical data generated every day, every week and every month into remote and cloud storage platforms.

A computer device includes a memory and a processor; and the memory having a computer program stored thereon, wherein the processor, when executing the computer program, implements the steps of the coordinated control method for energy storage of a multi-energy complementary distributed microgrid.

A computer-readable storage medium has a computer program stored thereon, wherein the computer program, when executed by a processor, implements the steps of the coordinated control method for energy storage of a multi-energy complementary distributed microgrid.

The present application has the beneficial effects that: in the present application, by combining the LSTM model with the ARIMA model, the accuracy of power and load prediction is improved; and the power distribution proportions and the charging and discharging rates of the energy storage units are dynamically adjusted by means of the virtual leader algorithm to guarantee the stable operation of a system under complex load fluctuation, so that the real-time fluctuation of the load and the power generation capacity can be adapted, and the operation efficiency of the energy storage system and the stability of the entire microgrid are improved.

### BRIEF DESCRIPTION OF THE DRAWINGS

In order to describe the technical solutions in the embodiments of the present application more clearly, the accompanying drawings required for describing the embodiments will be briefly introduced below. Apparently, the accompanying drawings in the following description show only some embodiments of the present application, and those of ordinary skill in the art may still derive other accompanying drawings from these accompanying drawings without creative efforts.

FIG. 1 is a schematic process diagram of a coordinated control method for energy storage of a multi-energy complementary distributed microgrid.

### DETAILED DESCRIPTION OF THE INVENTION

In order to make the above-mentioned objects, features, and advantages of the present application more obvious and comprehensible, the specific implementations of the present application will be described in detail below in conjunction with the accompanying drawings of the description.

A lot of specific details will be described in the following description to facilitate sufficiently understanding the present application. However, the present application can also be implemented in other ways different from ways described herein. Similar popularizations can be made by the skilled in the art without departing from the contents of the present application, and therefore, the present application is not limited by the following specific embodiments disclosed as below.

Next, “an embodiment” or “embodiments” mentioned herein refers to specific features, structures or characteristics included in at least one implementation of the present application. Therefore, the phrase “in an embodiment” appearing in different places throughout the description does not always refer to the same embodiment or an embodiment separately or selectively exclusive with other embodiments.

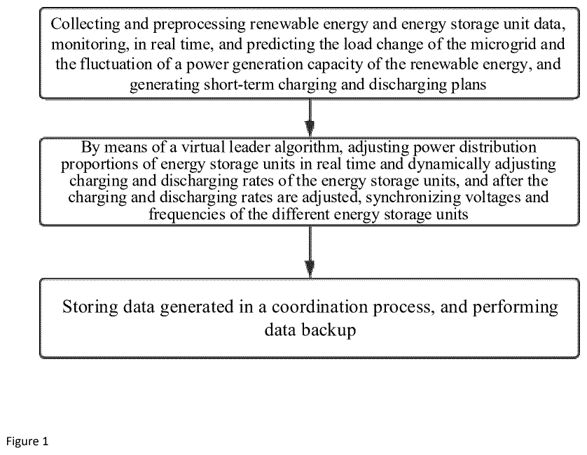

Embodiment 1, referring to FIG. 1, shown is a first embodiment of the present application. The embodiment provides a coordinated control method for energy storage of a multi-energy complementary distributed microgrid. The coordinated control method for energy storage of a multi-energy complementary distributed microgrid includes the following steps:
S1, renewable energy and energy storage unit data are collected and preprocessed, the load change of the microgrid and the fluctuation of a power generation capacity of the renewable energy are monitored in real time and are predicted, and short-term charging and discharging plans are generated;
specifically, the step that renewable energy and energy storage unit data are collected and preprocessed refers to a step that a sensor is deployed to collect photovoltaic and wind power generation data in the microgrid in real time, meanwhile, states of charges, power outputs, voltages and frequencies of the energy storage units are acquired, the acquired data is preprocessed, data noise and outliers are removed, and smoothing is performed.

By deploying the high-precision sensor, real-time monitoring for each energy storage node in the microgrid can be achieved, the timeliness and accuracy of data acquisition are guaranteed, and then, a reliable basic data is provided for energy scheduling; the sensor automatically acquires data without frequent artificial intervention, so that the efficiency of data acquisition is greatly increased, and errors possibly brought by manual operation are reduced; and by removing noise and outliers, errors generated by the sensor or in a communication process are eliminated, and the accuracy of the data is guaranteed. By data smoothing, the fluctuation of the data is further reduced, so that the system is more stable in a control process, the preprocessed data can reflect a state of the microgrid more truly, a wrong decision caused by data noise or errors is avoided, and thus, the response speed and scheduling efficiency of the system are increased.

Further, the step that the load change of the microgrid and the fluctuation of a power generation capacity of the renewable energy are monitored in real time and are predicted refers to a step that a load of the microgrid is predicted by using an LSTM model, historical and real-time photovoltaic and wind power generation data features are extracted by using a feature engineering, the extracted historical data feature as a training set is inputted to the LSTM model for model training, a loss function and an Adam optimizer are defined to perform iterative optimization of model parameters, iteratively outputting the model parameters for updating the LSTM model is stopped when the loss of the LSTM model is no longer reduced significantly in a process of continuous iteration, and the real-time photovoltaic and wind power generation data feature is inputted to the LSTM model to obtain future photovoltaic and wind power generation data; and
short-term load fluctuation of the energy storage units is predicted by using an ARIMA model, historical load data is collected and inputted to the ARIMA model for model training, model parameters are determined by maximum likelihood estimation, iteratively outputting the model parameters for updating the ARIMA model is stopped when the loss of the ARIMA model is no longer reduced significantly in a process of continuous iteration, and real-time load data of the energy storage units is inputted to the ARIMA model to obtain future load data.

By the feature engineer, key features are extracted from the historical and real-time data to ensure that the LSTM model can be effectively inputted. By combining the real-time monitoring with data extraction, not only is the real-time property of the system increased, but also a reliable basis is provided for subsequent power prediction and load scheduling. Due to the advantage of handling long-time sequence dependence, the LSTM model can better capture long-term and short-term load change trends in the microgrid. Based on the historical and real-time data extracted by using the feature engineer, the LSTM model can precisely predict power generation and load demands within a period of time in the future. In addition, due to the introduction of the Adam optimizer, the convergence speed of the model training is increased, it is ensured that the LSTM model reaches the optimal state in a shorter time, and prediction errors are reduced. The ARIMA model precisely models and predicts the short-term load fluctuation of the energy storage units, and the model parameters are optimized by the maximum likelihood estimation, so that it is ensured that the optimal fitting effect of the model to the historical load data is achieved. Such models can rapidly recognize power demand change in an energy storage system, thereby providing an important reference basis for the generation of the charging and discharging plans; and by combining prediction results of the LSTM model and the ARIMA model, the system can generate accurate short-term charging and discharging plans to ensure that the energy storage units are charged when the power generation capacity is excessive and are discharged when the power generation capacity is insufficient. The precision of the charging and discharging plans directly determines the operation efficiency of the energy storage system and the reasonable allocation of power resources.

Furthermore, the step that short-term charging and discharging plans are generated refers to a step that a power difference is computed according to a power prediction result and a load prediction result, charging and discharging states of an energy storage system are determined, if the power difference is greater than or equal to 0, it is indicated that the power generation capacity is excessive and the system is to charge the energy storage units, and if the power difference is less than 0, it is indicated that the power generation capacity is insufficient and the system requires the energy storage units to discharge.

By means of load prediction, the growth of future load demands can be known in advance, and the energy storage system can schedule the charging states of the energy storage units in advance according to the prediction results to ensure that sufficient electric energy can be used at the peak of the load. By computing the power difference, the energy storage system can determine, in real time, whether to store excess power or release stored energy so as to overcome the situation that the load demand is insufficient. When the power difference is positive, the energy storage system will automatically enter a charging state to store the excess power, thereby avoiding energy waste caused by excessive power generation; and when the power difference is negative, the energy storage system enters a discharging state to release the stored energy, thereby making up the situation of insufficient power supply, and ensuring that the load demand is met continuously and stably. By means of real-time computation of the power difference, the dynamic adjustment of the energy storage system is achieved, so that a microgrid system can cope with rapid load change and power generation fluctuation, and the response speed of the system is increased; and by predicting a future power generation capacity and load demand and reasonably planning working states of the energy storage units in the short-term charging and discharging plans, frequent charge and discharge of the energy storage system within an unnecessary time period are avoided, the service life of a device is prolonged, and meanwhile, the utilization efficiency of energy is increased.
S2, by means of a virtual leader algorithm, power distribution proportions of energy storage units are adjusted in real time and charging and discharging rates of the energy storage units are dynamically adjusted, and after the charging and discharging rates are adjusted, voltages and frequencies of the different energy storage units are synchronized;
specifically, the step that by means of a virtual leader algorithm, power distribution of energy storage units is updated in real time and charging and discharging rates of the energy storage units are dynamically adjusted refers to a step that a total power demand required to be borne by the energy storage units within the current time period according to a microgrid load demand predicted in the short-term discharging plan and power of the renewable energy:

$$D = {D}_{1} - ( {D}_{2} + {D}_{3} ) ,$$

wherein D is the total power demand required to be borne by the energy storage units at time t, D₁ is a load demand at the time t, and represents the total electricity consumption of the microgrid within the time period, D₂ and D₃ are photovoltaic and wind power generation prediction values at the time t;
a communication network among the energy storage units is established, and an initial power demand is distributed to each energy storage unit according to the computed total power demand and the SOC of each energy storage unit;
a communication weight between an energy storage unit i and an energy storage unit j is defined, (the communication weight depends on a physical distance among the energy storage units, device performances, respective SOC differences and other factors to ensure that more information is transferred among the energy storage units with shorter distances or similar states), an energy storage unit with the SOC closest to SOCₘₐₓ is selected as a leader, the selected leader is set as B=1, the remaining energy storage units are used as followers, it is set that 0<B≤1, and each energy storage unit shares state information by means of the communication network among the energy storage units;
when the energy storage unit i is a leader, its influences on the power distribution is completely dominant, and when the energy storage unit i is a follower, the influence of B is weaker, but reasonable power distribution adjustment can be still performed by means of reference information of a virtual leader and communication with a neighbor unit;
after the communication network is established, power distribution of each energy storage unit is continuously adjusted according to the guidance of the leader, and the power distribution of each energy storage unit is updated according to a formula:

$${x}_{i} [ k + 1 ] = {\sum }_{j = 1}^{N} {α}_{i , j} {x}_{j} [ k ] + B \cdot λ \cdot Δ {x}_{i} [ k ] ,$$

wherein xᵢ[k+1] is a power distribution proportion of the energy storage unit i at time k+1, α_{i,j} is a communication weight between the energy storage units i and j and represents a degree of an influence of information received from the energy storage unit j by the energy storage unit i, by means of network algorithm distribution, B is a leader indication parameter and represents whether the energy storage units i is the leader, λ is a coupling coefficient of a leader influence, represents a degree of an influence of the leader on the energy storage unit as the follower, is used for controlling the power of guidance of the leader to other energy storage units of the system, is usually designed and set by the system, and is adjusted according to an entire load state and a scheduling requirement of the system, and Δxᵢ[k] is a power distribution adjustment quantity of the energy storage unit i in a k^{th} iteration, represents variables of the power outputs of the energy storage units, is iteratively computed, and is dynamically adjusted every time according to SOCs, load demands, power generation prediction and other real-time information of the energy storage units;
each energy storage unit adjusts a power output thereof for iteration according to information transferred by the communication network and the guidance of the leader, a threshold of the number of iterations of the power distribution is set as Q by using a gradient descent method, and when the number of iterations reaches the threshold Q, a final power distribution proportion of each energy storage unit is outputted;
the distribution proportion is converted into a power distribution value of each energy storage unit by means of a proportional distribution algorithm (a simple proportional algorithm);
charging and discharging rates I of each energy storage unit are computed according to a computed power distribution result:

$$I = \frac{W}{A} \times ( \frac{{SOC}_{max} - {SOC}_{b}}{{SOC}_{max}} ) ,$$

wherein W is a power output, A is a voltage, SOCₘₐₓ is the maximum state of charge of the energy storage unit, and SOC_{b}, is the current state of charge of the energy storage unit; and
actual power output situations of the energy storage units are adjusted according to the computed charging and discharging rates.

By means of the virtual leader algorithm, the system can reasonably distribute the power output of each energy storage unit according to the real-time load demand and the SOC of the energy storage unit. Compared with a traditional static distribution method, the virtual leader algorithm has the characteristic of dynamic response, and can rapidly adjust the power distribution proportion during load fluctuation and renewable energy power generation change, thereby effectively reducing the phenomenon of power unbalance. Such a dynamic adjustment mechanism improves the coordination among the energy storage units, optimizes the operation efficiency of a grid, and is particularly applicable to a scenario with greater renewable energy fluctuation, and during power distribution selection, the SOC of each energy storage unit is considered in the virtual leader algorithm. By distributing a load to an energy storage unit with a relatively moderate SOC, the system can avoid overuse or idle of some energy storage units, thereby balancing charging and discharging behaviors of each unit. By means of such a distribution strategy, the frequent charging and discharging operations of each energy storage unit are significantly reduced, the service life of an energy storage device is prolonged, and the maintenance and replacement costs are reduced; and since each energy storage unit in the system shares the state information through the communication network and performs power distribution adjustment, the energy storage system can achieve a higher error tolerant capability. When abnormal state or power output fluctuation of a certain energy storage unit occurs, other units can rapidly perform adjustment according to the shared information to ensure the power stability of the entire microgrid. By using such a distributed coordinated control method, the dependency on single node is reduced, the robustness of the system is improved, and the risk of system crash brought by single-point failure is avoided; and due to a plurality of iterations performed according to a power distribution updating formula, the system can achieve precise power distribution among the plurality of energy storage units. Specifically speaking, the communication weight in the power distribution formula reflects a cooperative relationship among the energy storage units, and the guidance of the leader ensures that the power distribution of the entire system gradually tends to be optimized. By means of such a precise distribution strategy, precise matching between the power outputs of the energy storage units and an actual load demand is guaranteed, energy waste is avoided, and the precision and efficiency of energy management are improved; and the charging and discharging rates of each energy storage unit are further determined by computing the power distribution result, so that the charging and discharging rates of each energy storage unit can be precisely computed according to the power output and current voltage of the energy storage unit and a difference of the maximum state of charge and the current state of charge. By using such a dynamic adjustment method based on the power demand and the SOC, not only is the energy flow of the energy storage units optimized, but also overcharge or overdischarge of the energy storage units can be avoided, and thus, a health state of a battery is protected. The power distribution and the charging and discharging rates can be dynamically adjusted in real time, power waste is reduced, and power demands are reasonably distributed when a peak of the load is reached, so that the utilization rate of renewable energy is increased.

Further, the step that after the charging and discharging rates are adjusted, voltages and frequencies of the different energy storage units are synchronized refers to a step that after power distribution and charging and discharging rate adjustment are completed, the current frequency and voltage of each energy storage unit are acquired, and a frequency synchronization adjustment input up and a voltage adjustment input up are computed according to a frequency difference of the energy storage unit i and the energy storage unit j by means of a consensus algorithm:

$${u}_{i}^{ω} = - {\sum }_{j = 1}^{n} {w}_{ij} \frac{{( {ω}_{i} - {ω}_{j} )}^{η}}{1 + tanh ( ξ ( {θ}_{i} - {θ}_{j} )} + exp ( - \frac{\vert {P}_{i} - {P}_{j} \vert}{γ} ) ,$$

$${u}_{i}^{V} = min ( {U}_{max} , max ( 0 , - {w}_{ij} \frac{{( {V}_{i} - {V}_{j} )}^{2}}{1 + {e}^{- λ ( {ϕ}_{i} - {ϕ}_{j} )}} + \frac{1}{1 + {e}^{- ϛ ( {Q}_{i} - {Q}_{j} )}} ) ) ,$$

wherein wᵢⱼ is a coupling weight between the energy storage units i and j and represents the intensity of information exchange among nodes, ωᵢ and ωⱼ are frequencies of the energy storage units i and j, η is a power of the frequency difference, is used for adjusting a nonlinear response of the frequency difference, and is determined by system experiments or debugging, ξ is an adjustment coefficient of a phase angle difference, is used for controlling an influence of the phase angle difference on frequency adjustment, and is determined by experiment optimization, tanh( ) is a hyperbolic tangent function and is used for processing the phase angle difference, θᵢ and θⱼ are phase angles of the energy storage units i and j and are acquired by using a phase meter, Pᵢ and Pⱼ are power outputs of the energy storage units i and j, γ is an attenuation coefficient of power loss, is used for controlling an influence of the power difference on frequency synchronization, and is determined by experiments or designs, Vᵢ and Vⱼ are voltages of the energy storage units i and j and are main variables of voltage synchronization, λ is an adjustment coefficient of a voltage phase angle and is used for controlling an influence of the voltage phase angle difference on synchronous adjustment, φᵢ and φⱼ are voltage phase angles of the energy storage units i and j and are acquired by using a voltage phase angle sensor, ξ is an adjustment coefficient of reactive power synchronization and is used for adjusting an influence of a reactive power difference on voltage synchronization, Qᵢ and Qⱼ are reactive powers of the energy storage units i and j, max(0, . . . ) ensures that a voltage synchronization adjustment value is not a negative number and is used for preventing a voltage from being excessively reduced, min(Uₘₐₓ, . . . ) ensures that an adjustment value does not exceed the maximum voltage adjustment range Uₘₐₓ allowed by the system to avoid over-adjustment of the system, and Uₘₐₓ is the maximum voltage adjustment range;
frequency synchronization in the prior art mainly depends on the consensus algorithm in which the frequencies of the energy storage unit i and j are gradually adjusted by comparing the frequency difference therebetween until they are consistent:

$${u}_{i}^{ω} = - {\sum }_{j = 1}^{n} {w}_{ij} ( {ω}_{i} - {ω}_{i} ) ,$$

for such a method, adjustment is performed by means of the simple linear frequency difference, the response of the process of the frequency synchronization to the frequency difference is relatively simple, and in the case of a great frequency difference, the adjustment process may be excessively violent, which results in oscillation or system instability; in order to overcome the problem of linear response to the frequency difference in the prior art, a power response term η is introduced to nonlinearly process the frequency difference, so that the system is smoother for small-range frequency fluctuation; for a great frequency difference, the synchronization process can be accelerated to avoid long-time frequency unbalance, the phase angle difference θᵢ-θⱼ of the energy storage units can also affect the synchronization speed of the system, therefore, the phase angle difference is processed by introducing the hyperbolic tangent function tanh( ) and thus, more flexible synchronization adjustment is achieved; in the distributed energy storage system, the power output difference Pᵢ-Pⱼ of the energy storage units can also affect the frequency synchronization process; in order to further optimize the synchronization process, an exponential attenuation term

$$exp ( - \frac{\vert {P}_{i} - {P}_{j} \vert}{γ} )$$

related to the power difference is added in the formula; and by introducing the dynamic adjustment for the power difference, in the frequency synchronization, not only are the frequency difference and the phase angle difference considered, but also the synchronization speed can be adjusted according to the power difference, which is beneficial for the system to rapidly adjust the frequency during load fluctuation, thereby guaranteeing the stability of the system;
in the prior art, the control on voltage synchronization is usually achieved by means of the following consensus algorithm:

$${u}_{i}^{V} = - {\sum }_{j = 1}^{n} {w}_{ij} ( {V}_{i} - {V}_{j} ) ,$$

it is a linear formula, and a core thought thereof is to guarantee the consistency of the voltages of the energy storage units by performing weighted average adjustment on the voltage difference Vᵢ-Vⱼ of all the energy storage units, each energy storage unit adjusts its voltage output according to the voltage difference from other units, the processing for the voltage difference and the reactive power difference is excessively simple, precise control cannot be provided in a complex fluctuation environment, and therefore, a more flexible adjustment mechanism needs to be introduced to ensure that the energy storage units can perform adaptive adjustment according to the change of the system;
in order to avoid excessive adjustment when the voltage difference is greater, an exponential attenuation term e^{-λ(φ}^{ᵢ}^{-φ}^{ᵢ}⁾ of the phase angle difference is introduced, and the term is used for smoothing an adjustment range, so that the adjustment is more moderate in the case that the phase angle difference is greater, and the problem of system oscillation brought by a large-range phase angle difference is avoided;
in existing energy storage control technologies, a simple linear or weighted sum method is usually used to process the reactive power difference Qᵢ-Qⱼ, reactive power adjustment is an important part of voltage stability, however, processing means are relatively simple, the reactive power difference is processed by using an exponential function, when the reactive power difference is less, the adjustment range is wider, which ensures that the system can rapidly make a response; when the reactive power difference is greater, the adjustment range is gradually reduced, which avoids unnecessary excessive adjustment caused by overgreat reactive power difference; in traditional voltage synchronization control, usually, there are no strict upper and lower bounds of a range of an adjustment value, or the range is limited in a form of a simple saturation function, and a control mechanism for the upper and lower bounds is used, so that it is ensured that the adjustment value is within a safe range, and meanwhile, negative number adjustment is avoided; and
the frequencies and the voltages of the energy storage units are adjusted in real time according to computed synchronous inputs, the frequencies and the voltages of the energy storage units are updated, and the frequencies and the voltages of the different energy storage units are gradually synchronized.

Due to the synchronization of the frequencies and voltages of the energy storage units, unbalance phenomena in the grid are reduced, the entire stability of the system is improved, and voltage and frequency instability caused by power fluctuation is avoided; and by optimizing the synchronization process of the energy storage units, energy loss caused during power transmission is reduced. Due to the synchronization of the voltages and the frequencies, energy transmission among the energy storage units is more efficient, the excessive consumption of reactive power is reduced, and the energy efficiency of the system is increased; and due to the synchronization of the voltages and the frequencies, the energy storage units can be more coordinated when making a response to the load demand of the grid, competitions and conflicts among all the units in the process of power adjustment are reduced, and the response speed and efficiency are effectively increased. By means of computation with consideration of various parameters such as the frequency difference and the phase angle, the adjustment and input precision of the frequencies and the voltages is guaranteed, so that the adjustment of the energy storage units is more flexible and efficient. By using such a method, errors brought by single parameter adjustment in a traditional method are reflectively reduced, and each energy storage unit performs autonomous adjustment according to real-time situations of the frequencies and the voltages, and thus, the system has stronger robustness. When load fluctuation or energy storage unit failure occurs, rapid adjustment can be performed to ensure the stabile operation of the system; by computing the coupling weight and the frequency phase angle, the energy storage units can autonomously coordinate respective frequencies and voltages, which avoids excessive dependency on a central controller and improves the distributed control ability of the system; by adjusting the reactive power and the voltage phase angle, the voltage consistency of the different energy storage units is guaranteed, the problem of system instability brought by voltage fluctuation is avoided, and particularly, the voltage stability of the grid is guaranteed in the case of high load demand fluctuation; due to the reasonable adjustment of the reactive power, not only can the voltage stability be guaranteed, but also the power quality of the entire system can be improved, influences of voltage peaks and power fluctuation on a load can be reduced, and the efficient response of the system during load change can be guaranteed; and due to the synchronization of the reactive power and the adjustment of the voltage phase angle, the coordination among the energy storage units is enhanced, so that the energy storage units can achieve more stable energy management in a complex microgrid environment.
S3, data generated in a coordination process is stored, and data backup is performed;

specifically, the step that data generated in a coordination process is stored refers to a step that an operation log generated in a process of coordinated control for the microgrid is recorded in real time, the collected energy storage unit data and photovoltaic and wind power generation data as well as coordinated control data generated by analysis are stored into a database, the database is sorted in chronological order, and corresponding labels are marked.

The control data generated in the coordinated control process reflects a dynamic scheduling situation of each energy storage unit and photovoltaic and wind power generation units during the operation of the microgrid, and the storage of the data into the database is beneficial to the storage of a historical scheduling strategy, which has an important reference value for optimizing a future scheduling strategy. By analyzing historical coordinated control data, the system can find and predict potential problems in future operation and develops a more efficient scheduling strategy based on past experience; and due to the storage way of sorting in chronological order, the traceability of the data is guaranteed. The operation of the microgrid is a highly dynamic process, and data within different time periods reflects operation states of the system in different load situations. By sorting in chronological order, data analysis personnel can rapidly position a system behavior within a certain time period and evaluate an effect of the scheduling strategy. In addition, due to labeled storage, the retrieval efficiency of the data is increased, and the labels can be flexibly configured according to a dimension such as a data category, a source and time, so that the system can rapidly perform data classification and calling.

Further, the step that data backup is performed refers to a step that the data is stored into the database, meanwhile, synchronous data storage is performed by using a log file system and an internal memory database, a regular backup strategy is set, and historical data generated every day, every week and every month is regularly backed up into remote and cloud storage platforms.

By recording the change of each operation, it is ensured that the log file system can be restored to a certain safe state by rolling a log back when the system is failed, so that the possibility of data loss is reduced. Meanwhile, the internal memory database is introduced to further increase the processing speed of the data and is particularly applicable to real-time monitoring and high-frequency data writing-in scenarios. By means of synchronous data storage, the system can ensure that the data cannot be lost even if crash or network interruption occurs, and thus, the robustness of the system is improved. By setting the regular backup strategy, the system can perform different-frequency backup on the data generated every time, every week and every month, so that the historical integrity of the data and the safety of long-term storage are guaranteed. Due to regular backup, historical data loss caused by unforeseen circumstances can be reduced, and meanwhile, risks caused by artificial operation are reduced by means of an automatic backup process. Particularly, in a distributed system, the regular backup strategy can reduce the problem of data consistency brought by system update or failure.

Embodiment 2 is a second embodiment of the present application, and the embodiment is different from the previous embodiment in that:
when the function is implemented in a form of a software function unit and sold or used as an independent product, the function may be stored in a computer-readable storage medium. Based on such understanding, the essences of the technical solutions of the present application or parts thereof making contributions to the prior art or parts of the technical solutions may be embodied in a form of a software product, and the computer software product is stored in a storage medium and includes a plurality of instructions used to enable a computer device (which may be a personal computer, a server, or a network device, etc.) to perform all or parts of steps of the method in each of the embodiments of the present application. The aforementioned storage medium includes various media capable of storing program codes, such as a U disk, a mobile hard disk, an ROM (Read-Only Memory), an RAM (Random Access Memory), a diskette, and an optical disk.

Logics and/or steps shown in the process diagram or described herein in other ways, such as an ordered list of executable instructions regarded to be used for implementing logic functions, may be specifically implemented in any computer-readable medium so as to be used by instruction execution systems, apparatuses or devices (such as a computer-based system, a system including a processor or other systems capable of acquiring instructions from the instruction execution systems, apparatuses or devices and executing the instructions) or be used in conjunction with the instruction execution systems, apparatuses or devices. For the purpose of the present description, the “computer-readable medium” may be any apparatus capable of including, storing, communicating, propagating or transmitting programs so as to be used by the instruction execution systems, apparatuses or devices or used in conjunction with the instruction execution systems, apparatuses or devices.

More specific examples (non-exhaustive list) of the computer-readable medium are shown as follows: an electric connection part (electronic apparatus) with one or more wirings, a portable computer disk enclosure (magnetic apparatus), a random access memory (RAM), a read-only memory (ROM), an erasable programmable read-only memory (EPROM or flash memory), an optical fiber apparatus, and a portable compact disc read-only memory (CDROM). In addition, the computer-readable medium may be even paper or other appropriate media on which the program can be printed, which is due to a fact, for example, that the program can be acquired in an electronic way by optically scanning the paper or other media, and next processing the same in other appropriate ways during edition, interpretation or requirement, and then, the program is stored in a computer memory.

It should be understood that all parts of the present application may be implemented by means of hardware, software, firmware or their combinations. In the above-mentioned embodiments, the plurality of steps or methods may be implemented by software or firmware stored in a memory and executed by the appropriate instruction execution systems. For example, if they are implemented by means of the hardware, it is the same as that in another embodiment that they may be implemented by any one of the following technologies known in the art or their combinations: a discrete logic circuit with a logic gate circuit for implementing a logic function for a data signal, an application-specific integrated circuit with an appropriate combined logic gate circuit, a programmable gate array (PGA), a field-programmable gate array (FPGA), etc.

1. A coordinated control method for energy storage of a multi-energy complementary distributed microgrid, comprising:
collecting and preprocessing renewable energy and energy storage unit data, monitoring, in real time, and predicting the load change of the microgrid and the fluctuation of a power generation capacity of the renewable energy, and generating short-term charging and discharging plans;
by means of a virtual leader algorithm, adjusting power distribution proportions of energy storage units in real time and dynamically adjusting charging and discharging rates of the energy storage units, and after the charging and discharging rates are adjusted, synchronizing voltages and frequencies of the different energy storage units; and
storing data generated in a coordination process, and performing data backup; wherein
the collecting and preprocessing renewable energy and energy storage unit data refers to deploying a sensor to collect photovoltaic and wind power generation data in the microgrid in real time, meanwhile, acquiring states of charges, power outputs, voltages and frequencies of the energy storage units, preprocessing the acquired data, removing data noise and outliers, and performing smoothing;
the monitoring, in real time, and predicting the load change of the microgrid and the fluctuation of a power generation capacity of the renewable energy refers to predicting a load of the microgrid by using an LSTM (Long Short Term Memory) model, extracting historical and real-time photovoltaic and wind power generation data features by using a feature engineering, inputting the extracted historical data feature as a training set to the LSTM model for model training, defining a loss function and an Adam optimizer to perform iterative optimization of model parameters, stopping iteratively outputting the model parameters for updating the LSTM model when the loss of the LSTM model is no longer reduced significantly in a process of continuous iteration, and inputting the real-time photovoltaic and wind power generation data feature to the LSTM model to obtain future photovoltaic and wind power generation data; and
predicting short-term load fluctuation of the energy storage units by using an ARIMA (Autoregressive Integrated Moving Average) model, collecting and inputting historical load data to the ARIMA model for model training, determining model parameters by maximum likelihood estimation, stopping iteratively outputting the model parameters for updating the ARIMA model when the loss of the ARIMA model is no longer reduced significantly in a process of continuous iteration, and inputting real-time load data of the energy storage units to the ARIMA model to obtain future load data;
the generating short-term charging and discharging plans refers to computing a power difference according to a power prediction result and a load prediction result, determining charging and discharging states of an energy storage system, if the power difference is greater than or equal to 0, indicating that the power generation capacity is excessive and the system is to charge the energy storage units, and if the power difference is less than 0, indicating that the power generation capacity is insufficient and the system requires the energy storage units to discharge;
the by means of a virtual leader algorithm, updating power distribution of energy storage units in real time and dynamically adjusting charging and discharging rates of the energy storage units refers to computing a total power demand required to be borne by the energy storage units within the current time period according to a microgrid load demand predicted in the short-term discharging plan and power of the renewable energy;
establishing a communication network among the energy storage units, and distributing an initial power demand to each energy storage unit according to the computed total power demand and the SOC (state of charge) of each energy storage unit;
defining a communication weight between an energy storage unit i and an energy storage unit j, selecting an energy storage unit with the SOC closest to SOCₘₐₓ as a leader, setting the selected leader as B=1, using the remaining energy storage units as followers, setting that 0<B≤1, and sharing state information by each energy storage unit by means of the communication network among the energy storage units;
after the communication network is established, continuously adjusting power distribution of each energy storage unit according to the guidance of the leader, and updating the power distribution of each energy storage unit according to a formula:
$${x}_{i} [ k + 1 ] = {\sum }_{j = 1}^{N} {α}_{i , j} {x}_{j} [ k ] + B \cdot λ \cdot Δ {x}_{i} [ k ] ,$$
wherein xᵢ[k+1] is a power distribution proportion of the energy storage unit i at time k+1, α_{i,j} is a communication weight between the energy storage units i and j, B is a leader indication parameter, λ is a coupling coefficient of a leader influence, and Δxᵢ[k] is a power distribution adjustment quantity of the energy storage unit i in a k^{th} iteration;
adjusting, by each energy storage unit, a power output thereof for iteration according to information transferred by the communication network and the guidance of the leader, setting a threshold of the number of iterations of the power distribution as Q, and when the number of iterations reaches the threshold Q, outputting a final power distribution proportion of each energy storage unit;
converting the distribution proportion into a power distribution value of each energy storage unit by means of a proportional distribution algorithm;
computing charging and discharging rates I of each energy storage unit according to a computed power distribution result:
$$I = \frac{W}{A} \times ( \frac{{SOC}_{max} - {SOC}_{b}}{{SOC}_{max}} ) ,$$
wherein W is a power output, A is a voltage, SOCₘₐₓ is the maximum state of charge of the energy storage unit, and SOC_{b} is the current state of charge of the energy storage unit; and
adjusting actual power output situations of the energy storage units according to the computed charging and discharging rates;
the after the charging and discharging rates are adjusted, synchronizing voltages and frequencies of the different energy storage units refers to after power distribution and charging and discharging rate adjustment are completed, acquiring the current frequency and voltage of each energy storage unit, and computing a frequency synchronization adjustment input
$${u}_{i}^{ω}$$
and a voltage adjustment input uᵢ^{v} according to a frequency difference of the energy storage unit i and the energy storage unit j by means of a consensus algorithm;
$${u}_{i}^{ω} = - {\sum }_{j = 1}^{n} {w}_{ij} \frac{{( {ω}_{i} - {ω}_{j} )}^{η}}{1 + tanh ( ξ ( {θ}_{i} - {θ}_{j} )} + exp ( - \frac{\vert {P}_{i} - {P}_{j} \vert}{γ} ) ,$$
$${u}_{i}^{V} = min ( {U}_{max} , max ( 0 , - {w}_{ij} \frac{{( {V}_{i} - {V}_{j} )}^{2}}{1 + {e}^{- λ ( {ϕ}_{i} - {ϕ}_{j} )}} + \frac{1}{1 + {e}^{- ϛ ( {Q}_{i} - {Q}_{j} )}} ) ) ,$$
wherein wᵢⱼ is a coupling weight between the energy storage units i and j, ωᵢ and ωⱼ are frequencies of the energy storage units i and j, η is a power of the frequency difference, ξ is an adjustment coefficient of a phase angle difference, tanh( ) is a hyperbolic tangent function, θᵢ and θⱼ are phase angles of the energy storage units i and j, Pᵢ and Pⱼ are power outputs of the energy storage units i and j, γ is an attenuation coefficient of power loss, Vᵢ and Vᵢ are voltages of the energy storage units i and j, λ is an adjustment coefficient of a voltage phase angle, φᵢ and φⱼ are voltage phase angles of the energy storage units i and j, ξ is an adjustment coefficient of reactive power synchronization, Qᵢ and Qⱼ are reactive powers of the energy storage units i and j, and Uₘₐₓ is the maximum voltage adjustment range; and
adjusting the frequencies and the voltages of the energy storage units in real time according to computed synchronous inputs, updating the frequencies and the voltages of the energy storage units, and gradually synchronizing the frequencies and the voltages of the different energy storage units.

2. The coordinated control method for energy storage of a multi-energy complementary distributed microgrid of claim 1, wherein the storing data generated in a coordination process refers to recording, in real time, an operation log generated in a process of coordinated control for the microgrid, storing the collected energy storage unit data and photovoltaic and wind power generation data as well as coordinated control data generated by analysis into a database, sorting the database in chronological order, and marking corresponding labels.

3. The coordinated control method for energy storage of a multi-energy complementary distributed microgrid of claim 2, wherein the performing data backup refers to storing the data into the database, meanwhile, performing synchronous data storage by using a log file system and an internal memory database, setting a regular backup strategy, and regularly backing up historical data generated every day, every week and every month into remote and cloud storage platforms.

4. A computer device, comprising a memory and a processor; and the memory having a computer program stored thereon, wherein the processor, when executing the computer program, implements the steps of the coordinated control method for energy storage of a multi-energy complementary distributed microgrid of any one of claim 3.

5. A computer-readable storage medium having a computer program stored thereon, wherein the computer program, when executed by a processor, implements the steps of the coordinated control method for energy storage of a multi-energy complementary distributed microgrid of any one of claim 3.
